(19) United States
(12) Patent Application Publication
(10) Pub. No.: US 2026/0148545 A1
(43) Pub. Date: May 28, 2026

(54) IMAGE MANAGEMENT METHOD, SERVER AND IMAGE CAPTURE DEVICE

(71) Applicant: Industrial Technology Research Institute, Hsinchu (TW)

(72) Inventors: Yao-Chin Yang, Hsinchu City (TW); Yi-Yu Su, Hsinchu City (TW); Kun-Hsien Lu, Kaohsiung City (TW); Ting-Wei Fan, Taoyuan City (TW)

(73) Assignee: Industrial Technology Research Institute, Hsinchu (TW)

(21) Appl. No.: 19/033,531

(22) Filed: Jan. 22, 2025

(30) Foreign Application Priority Data
Nov. 25, 2024 (TW) 113145323

(51) Int. Cl. G06V 10/98; G06T 7/73; G06V 20/52; G06V 40/10

(52) U.S. Cl. CPC G06V 10/993; G06T 7/73; G06V 40/10; G06T 2207/30168; G06T 2207/30196; G06V 20/52; G06V 2201/07

(57) ABSTRACT

The disclosure provides an image management method, server and image capture device. The method performs image inspection operations on uninspected second images among multiple first images arranged in chronological order. The operations include: identifying target objects and determining their orientations; evaluating the completeness of various parts of the target objects based on their orientations; and generating corresponding completeness codes. Finally, the image with the highest completeness code is selected as the target image for output. This method effectively filters out the most suitable images for person re-identification, thereby enhancing overall system performance.

### CROSS-REFERENCE TO RELATED APPLICATION

This application claims the priority benefit of Taiwan application serial no. 113145323, filed on Nov. 25, 2024. The entirety of the above-mentioned patent application is hereby incorporated by reference herein and made a part of this specification.

### BACKGROUND

### Technical Field

The present disclosure relates to an image processing technology, which relates to an image management method, server and image capture device, and can select an optimal target image by determining orientation and completeness of a target object in the image.

### Description of Related Art

With the development of commercial venues such as smart retail, shopping malls and amusement parks, using image analysis technology to obtain customer trajectory information has become an important basis for business strategy planning. Among them, cross-camera person re-identification technology is key to achieving accurate trajectory analysis.

However, traditional person re-identification solutions often capture images when only a partial person appears. This situation is unfavorable for obtaining more complete person images, thereby affecting the accuracy of person re-identification.

### SUMMARY

The present disclosure provides an image management method and an electronic device using the method, so as to output an image having an optimal completeness of a target object, thereby solving the above problems in the existing technology. The method of the present disclosure can effectively improve a recognition confidence value in recognition operation corresponding to the target object of the output image, and improve execution efficiency and accuracy of an image recognition model.

One or more embodiments of the present disclosure provide an image management method, comprising: based on a plurality of first images arranged in chronological order, performing an image inspection operation on a plurality of uninspected second images among the plurality of first images. The image inspection operation comprises: identifying a target object in each second image and determining an orientation of the target object; based on the orientation, determining completeness of a plurality of parts of the target object; and based on the orientation and the completeness of each of the plurality of parts, obtaining a completeness code corresponding to the target object, so as to complete the image inspection operation corresponding to the second image. Furthermore, based on the completeness code of each of the inspected plurality of second images, selecting and outputting a target image corresponding to a maximum completeness code from the plurality of second images, wherein a recognition confidence value of the target object in the target image is greater than recognition confidence values of the target object in each of other second images among the plurality of second images.

One or more embodiments of the present disclosure provide a server, comprising: a processor; a memory coupled to the processor; and a storage device coupled to the processor, wherein the storage device stores a plurality of program modules. The processor is configured to execute the plurality of program modules to: based on a plurality of first images arranged in chronological order, perform an image inspection operation on a plurality of uninspected second images among the plurality of first images; and based on the completeness code of each of the inspected plurality of second images, select and output a target image corresponding to a maximum completeness code from the plurality of second images, wherein a recognition confidence value of the target object in the target image is greater than recognition confidence values of the target object in each of other second images among the plurality of second images. The image inspection operation comprises: identifying a target object in each second image and determining an orientation of the target object; based on the orientation, determining completeness of a plurality of parts of the target object; and based on the orientation and the completeness of each of the plurality of parts, obtaining a completeness code corresponding to the target object, so as to complete the image inspection operation corresponding to the second image.

One or more embodiments of the present disclosure provide an image capture device, comprising: a camera module for capturing a plurality of first images; a processor; a memory coupled to the processor; and a storage device coupled to the processor, wherein the storage device stores a plurality of program modules. The processor is configured to execute the plurality of program modules to: based on the plurality of first images arranged in chronological order, perform an image inspection operation on a plurality of uninspected second images among the plurality of first images, wherein the image inspection operation comprises: identifying a target object in each second image and determining an orientation of the target object; based on the orientation, determining completeness of a plurality of parts of the target object; and based on the orientation and the completeness of each of the plurality of parts, obtaining a completeness code corresponding to the target object, so as to complete the image inspection operation corresponding to the second image. Furthermore, based on the completeness code of each of the inspected plurality of second images, select and output a target image corresponding to a maximum completeness code from the plurality of second images, wherein a recognition confidence value of the target object in the target image is greater than recognition confidence values of the target object in each of other second images among the plurality of second images.

Based on the above, the image management method and electronic device (e.g., server or image capture device) applying the method provided by the present disclosure can solve technical problems in the existing technology, where AI models tend to capture when only a partial person appears and cannot effectively determine completeness of person images. Through systematic inspection of chronological images, including determining orientation of target objects and determining completeness of multiple parts based on the orientation, then generating completeness codes, and finally selecting an image with the maximum completeness code as output. This method not only overcomes the drawbacks in the existing technology where detection confidence and detection frame ratio cannot effectively determine completeness, but can also automatically select target object images of the best quality from continuous images, significantly improving the accuracy of subsequent person re-identification.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a monitoring system according to an embodiment of the present disclosure.

FIG. 2 is a block diagram of a server according to an embodiment of the present disclosure.

FIG. 3 is a block diagram of an image capture device according to an embodiment of the present disclosure.

FIG. 4 is a block diagram of a monitoring system according to another embodiment of the present disclosure.

FIG. 5 is a block diagram of an encoder according to an embodiment of the present disclosure.

FIG. 6 is a flowchart of an image management method according to an embodiment of the present disclosure.

FIG. 7A is a schematic diagram of a plurality of key points corresponding to a target object according to an embodiment of the present disclosure.

FIG. 7B is a flowchart of determining an orientation of a target object according to an embodiment of the present disclosure.

FIG. 8 is a flowchart of obtaining a key point set corresponding to a head based on an orientation of a target object according to an embodiment of the present disclosure.

FIG. 9 is a flowchart of obtaining a key point set corresponding to upper limbs based on an orientation of a target object according to an embodiment of the present disclosure.

FIG. 10 is a flowchart of obtaining a key point set corresponding to lower limbs based on an orientation of a target object according to an embodiment of the present disclosure.

FIG. 11 is a flowchart of determining completeness of a part based on a plurality of key points of a key point set of the part according to an embodiment of the present disclosure.

FIG. 12 is a schematic diagram of a completeness code list according to an embodiment of the present disclosure.

FIG. 13A is a schematic diagram of performing completeness coding on a plurality of images according to an embodiment of the present disclosure.

FIG. 13B is a schematic diagram of outputting a target image by analyzing a numerical trend of a code sequence according to an embodiment of the present disclosure.

FIG. 13C is a schematic diagram of performing completeness coding on a plurality of images according to an embodiment of the present disclosure.

FIG. 14 is a schematic diagram of obtaining a target image based on a numerical trend of a code sequence of a plurality of completeness codes corresponding to a plurality of images according to an embodiment of the present disclosure.

### DESCRIPTION OF THE EMBODIMENTS

Reference is made in detail to embodiments of the disclosure, examples of which are illustrated in the accompanying drawings. The same or similar reference numerals are used to denote the same or similar elements wherever possible in the figures and description.

It should be understood that the terms “system” and “network” are often used interchangeably in the present disclosure. The term “and/or” in the present disclosure is only used to describe association relationships between associated objects, which means there may be four relationships, for example, A and/or B may mean four situations: A, B, A and B, A or B. Additionally, the character “/” in the present disclosure generally indicates that the associated objects are in an “or” relationship.

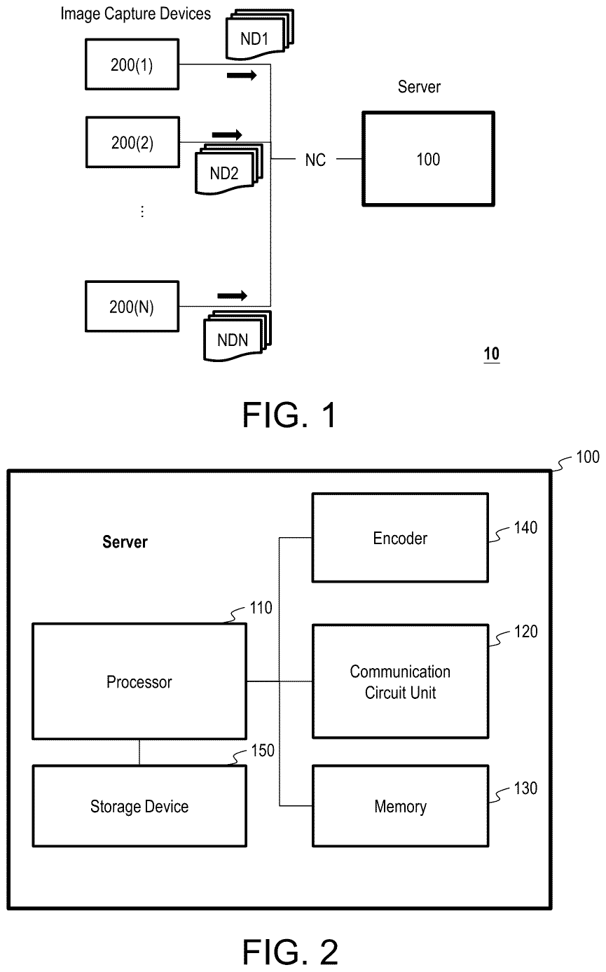

FIG. 1 is a block diagram of a monitoring system according to an embodiment of the present disclosure.

Referring to FIG. 1, in an embodiment, a monitoring system 10 comprises a plurality of image capture devices 200(1)-200(N) and a server 100. The server 100 and the image capture devices 200(1)-200(N) are communicatively connected through a network connection NC, wherein each of the image capture devices 200(1)-200(N) can respectively capture in real time a plurality of first images within corresponding monitoring areas (fields of view), and transmit the captured first images to the server 100 through the network connection NC. Each group of first images captured by each of the image capture devices 200(1)-200(N) is respectively recorded as ND1-NDN.

The server 100 is used to execute functions of person detection tracking, skeleton posture detection, image inspection and person re-identification. The server 100 is configured to execute program modules to process the plurality of first images from the image capture devices 200(1)-200(N). The image capture devices 200(1)-200(N) can be IP cameras or other electronic devices that execute image capture functions through visible light or invisible light.

Through the above architecture, when a target object moves through monitoring areas of different image capture devices 200(1)-200(N), the server 100 can receive these first images in real time, and perform image inspection operations on a plurality of second images containing the target object among these first images, so as to generate completeness codes, and select a target image having optimal completeness corresponding to the target object for subsequent analysis and processing.

FIG. 2 is a block diagram of a server according to an embodiment of the present disclosure.

Referring to FIG. 2, in an embodiment, the server 100 includes a processor 110, a storage device 120, a memory 130, a communication circuit unit 140 and an encoder 150, wherein the processor 110 is respectively electrically coupled to the storage device 120, the memory 130, the communication circuit unit 140 and the encoder 150.

The communication circuit unit 140 is used to establish the network connection NC to receive the plurality of first images from the plurality of image capture devices. The storage device 120 stores a plurality of program modules, these program modules can comprise, for example, a completeness encoding module, a key point recognition module, an image recognition module, and a confidence value assessment module. In another embodiment, these program modules can further comprise: a person detection tracking module, a skeleton posture detection module and a person re-identification unit.

The memory 130 is used to temporarily store data required by the processor 110 when executing these program modules.

The processor 110 is configured to execute program modules, image recognition models, neural network models and/or AI models stored in the storage device 120 to implement the image management method of the present disclosure. For example, identifying a plurality of second images containing a target object from the plurality of first images, and selecting an optimal target image corresponding to the target object.

The encoder 150 is a specific circuit unit configured to perform completeness analysis on the target object in each second image. Specifically, the encoder 150 can determine an orientation of the target object, and further determine completeness of a plurality of parts of the target object based on the orientation, so as to generate corresponding completeness code.

For example, when the target object is a person image, the encoder 150 can determine whether it is in a front-facing direction, a side-facing direction or a back-facing direction based on skeleton node positions of the person. Then, the encoder 150 can evaluate completeness of head image, upper limb image and lower limb image of the person based on the determined orientation, and generate a completeness code. Finally, the processor 110 can select a target image most suitable for person identification or person re-identification (Re-ID) from the plurality of second images based on these completeness codes.

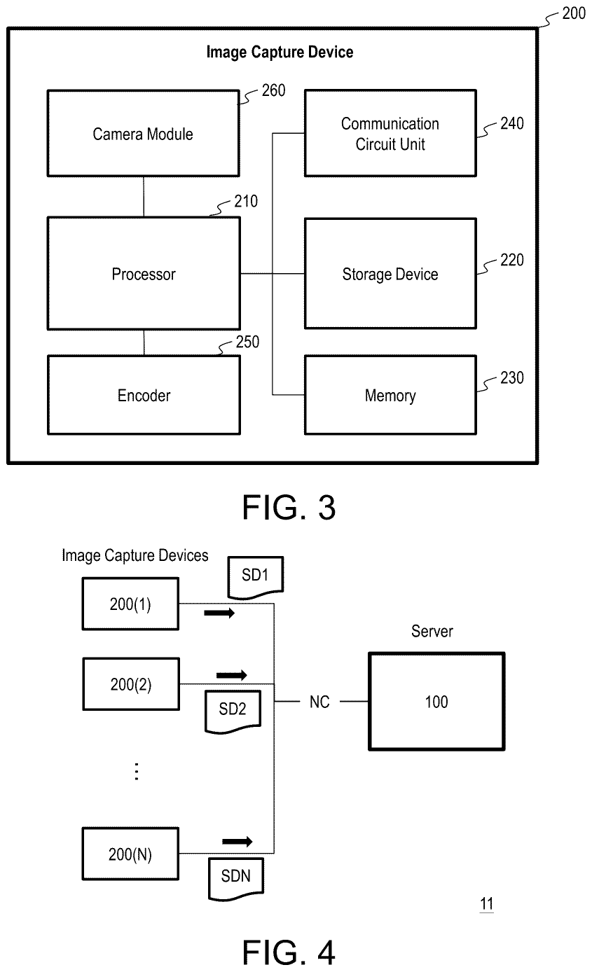

FIG. 3 is a block diagram of an image capture device according to an embodiment of the present disclosure.

Referring to FIG. 3, in another embodiment, an image capture device 200 can apply the image management method of the present disclosure. Specifically, the image capture device 200 comprises a camera module 260, a processor 210, a storage device 220, a memory 230, a communication circuit unit 240 and an encoder 250, wherein the processor 210 is respectively electrically coupled to the camera module 260, the storage device 220, the memory 230, the communication circuit unit 240 and the encoder 250.

The camera module 260 is used to capture a plurality of first images within a monitoring area. The communication circuit unit 240 is used to communicate with a server, receive target object instructions from the server, and transmit processed target images to the server. The storage device 220 stores a plurality of program modules, these program modules comprise a person detection tracking unit and a skeleton posture detection unit. The memory 230 is used to temporarily store data required by the processor 210 when executing these program modules.

For example, in practical applications, the processor 210 can obtain identification information or parameters corresponding to a target object based on target object instructions. When the camera module 260 continuously captures first images within the monitoring area, the processor 210 can execute program modules stored in the storage device 220 to identify a plurality of second images containing specific target objects from these first images based on target object instructions. Then, the encoder 250 can perform completeness analysis on the target objects in these second images to generate corresponding completeness codes. Finally, the processor 210 can select a target image with optimal completeness based on these completeness codes, and transmit the target image to the server through the communication circuit unit 240. That is, after applying the image management method provided by the present disclosure, the image capture device 200 can directly output images having optimal completeness of target objects based on the target objects for subsequent analysis/processing.

For example, if the image capture device 200 is installed at a mall entrance, when customers enter the monitoring area, the camera module 260 can capture continuous images of all customers in real time. The processor 210 can analyze orientation and completeness of specific customers in these images in real time, and generate completeness codes through the encoder 250, so as to select images with optimal completeness as target images for subsequent processing (e.g., person re-identification) by the server 100.

Through the above architecture, the image capture device 200 of the present embodiment can perform image filtering at the edge in real time, which can reduce network transmission load and server computation burden compared to transmitting all images to the server for processing. Furthermore, since the image capture device 200 has completeness analysis capability, it can ensure that target images transmitted to the server have sufficient completeness, helping to improve accuracy of subsequent person re-identification.

In an embodiment, the processor 110, 210 can be a Central Processing Unit (CPU), Graphics Processing Unit (GPU), Digital Signal Processor (DSP), Application-Specific Integrated Circuit (ASIC), Field-Programmable Gate Array (FPGA) or other computing units suitable for executing the method of the present disclosure.

The storage device 120, 220 can be a hard disk drive, solid state drive, flash memory or other non-volatile storage media. The storage device 120 is used to store various data that needs to be preserved for a long time, such as program modules, image recognition models, neural network models, AI models and/or other data required for implementing the method of the present disclosure. Furthermore, the storage device 120 can also store software such as operating systems and applications.

The memory 130, 230 can be Random Access Memory (RAM), Cache Memory, Dynamic Random Access Memory (DRAM), Static Random Access Memory (SRAM) or other volatile memory. The memory 130, 230 is used to temporarily store data required for processor computation, such as temporary data of image data, skeleton node data and completeness codes. Furthermore, the memory 130, 230 can also temporarily store variables and intermediate computation results required during program execution.

The camera module 260 can be a Fixed Focus Camera, Zoom Camera, Panoramic Camera, Infrared Camera, Depth Camera or other suitable imaging device or camera for capturing surveillance images. The camera module 260 is used to capture images within the monitoring area, for example, continuously capturing monochrome images, color images or infrared images at a preset sampling frequency.

FIG. 4 is a block diagram of a monitoring system according to another embodiment of the present disclosure.

Referring to FIG. 4, in an embodiment, a monitoring system 11 comprises a plurality of image capture devices 200(1)-200(N) and a server 100. The server 100 and the image capture devices 200(1)-200(N) are communicatively connected through a network connection NC.

Each of the image capture devices 200(1)-200(N) includes a camera module 260, a processor 210, a storage device 220, a memory 230, a communication circuit unit 240 and an encoder 250 as shown in FIG. 3.

Specifically, the camera module 260 of each image capture device 200(1)-200(N) can capture a plurality of first images within corresponding monitoring areas. After the processor 210 identifies a plurality of second images containing target objects, the encoder 250 can perform completeness analysis on the target objects in these second images to generate corresponding completeness codes. Then, the processor 210 can select images with optimal completeness as target images based on these completeness codes. Finally, each image capture device 200(1)-200(N) can transmit the selected target images (respectively recorded as SD1-SDN) to the server 100 through its communication circuit unit 240 via the network connection NC.

Through the above architecture, each image capture device 200(1)-200(N) in the present embodiment only needs to transmit target images with optimal completeness to the server 100, which can greatly reduce network transmission volume. Furthermore, since quality of target images is guaranteed at the edge, the server 100 can directly perform person re-identification processing without additional image filtering steps.

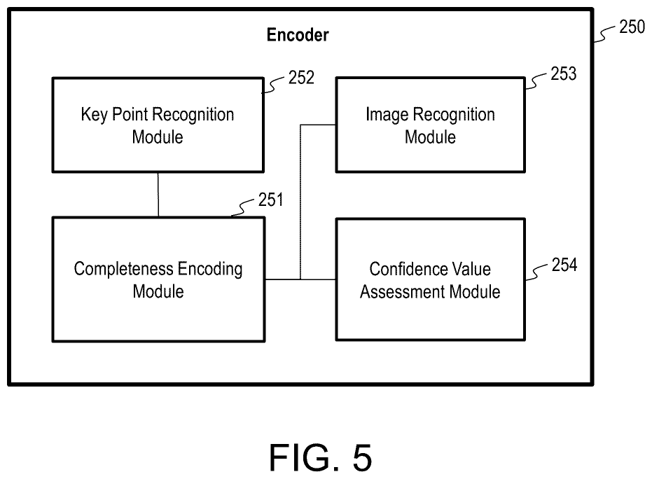

FIG. 5 is a block diagram of an encoder according to an embodiment of the present disclosure.

Referring to FIG. 5, in an embodiment, the encoder 250 includes an image recognition module 253, a key point recognition module 252, a confidence value assessment module 254 and a completeness encoding module 251. These modules can be implemented by software, hardware or software-hardware integration.

Specifically, the image recognition module 253 is configured to receive the first images and perform image recognition on the first images to identify a plurality of second images containing target objects. For example, when the target object is a person, the image recognition module 253 can identify regions containing that person in the images.

The key point recognition module 252 is configured to perform posture analysis (e.g., skeleton posture analysis) on the target object to set corresponding key points.

In an embodiment, the target object of the present disclosure refers to an image corresponding to a person. When the image capture device captures an image containing a person, the person in the image is the target object. The system will analyze orientation and completeness of various parts of the target object.

Specifically, the orientation includes: a front-facing direction, a side-facing direction and a back-facing direction corresponding to the person. For example, when the person faces the image capture device, it is determined as front-facing direction; when the left side or right side of the person faces the image capture device, it is determined as side-facing direction; when the person faces away from the image capture device, it is determined as back-facing direction. The plurality of parts includes a head image corresponding to the head of the person, an upper limb image corresponding to the upper limbs of the person, and a lower limb image corresponding to the lower limbs of the person. The head image contains the person's head region, such as eyes, ears and nose features; the upper limb image contains the person's upper body region, such as shoulders, arms and wrists; the lower limb image contains the person's lower body region, such as hips, knees and ankles.

Furthermore, the key point recognition module 252 can identify a plurality of key points of the target object, for example, when the target object is a person, after performing skeleton posture analysis on the person, obtainable key points include critical nodes of human body such as eyes, ears, nose, shoulders, elbows, wrists, hips, knees and ankles.

The confidence value assessment module 254 is configured to perform confidence value assessment on each key point. For example, the confidence value assessment module 254 can calculate corresponding confidence values based on visibility and clarity of each key point. When the confidence value exceeds a preset confidence value threshold, it indicates that the key point can be reliably identified.

The completeness encoding module 251 is configured to determine orientation of the target object based on position relationships of key points, and determine completeness based on confidence values of key points of various parts, so as to generate corresponding completeness code. For example, the completeness encoding module 251 can determine person's orientation based on relative positions of left and right shoulder key points, and evaluate completeness of parts such as head, upper limbs and lower limbs based on confidence values of key points.

Through the above architecture, the encoder 250 can effectively integrate orientation information and completeness information of various parts of the target object to generate a completeness code that reflects overall quality of the target object, helping to select target images most suitable for subsequent person re-identification.

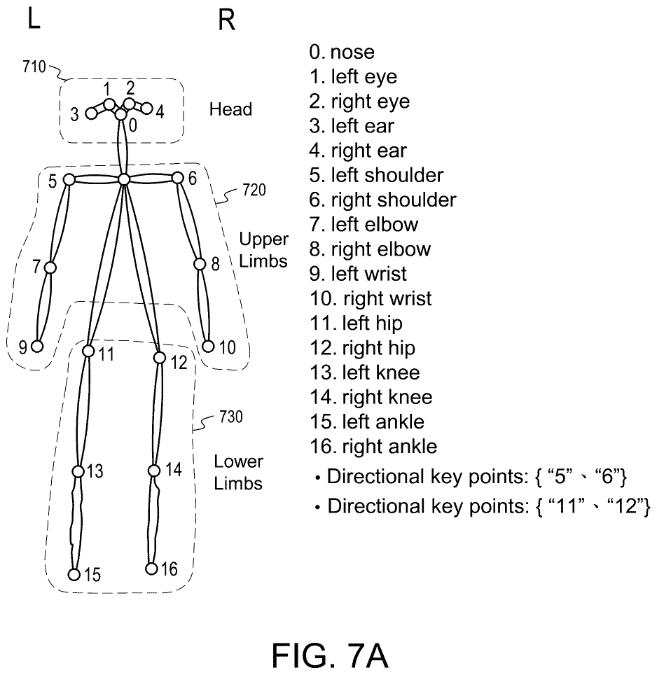

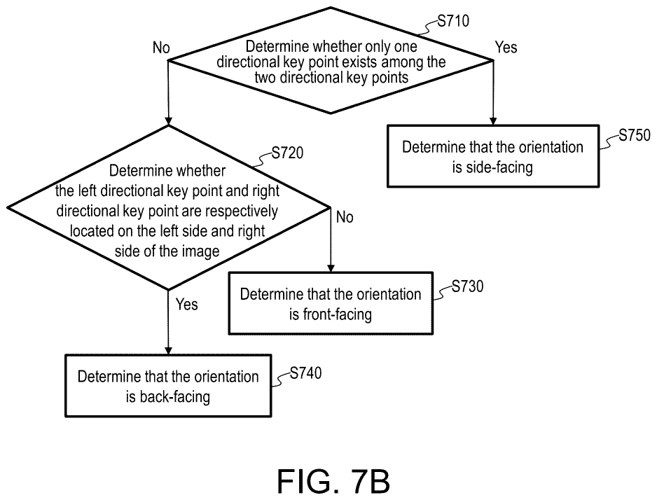

FIG. 7A is a schematic diagram of a plurality of key points corresponding to a target object according to an embodiment of the present disclosure.

Referring to FIG. 7A, in an embodiment, the key point recognition module 252 can identify a plurality of key points on the target object, these key points include: nose 0, left eye 1, right eye 2, left ear 3, right ear 4, left shoulder 5, right shoulder 6, left elbow 7, right elbow 8, left wrist 9, right wrist 10, left hip 11, right hip 12, left knee 13, right knee 14, left ankle 15 and right ankle 16. Wherein, L indicates the left side in the image, R indicates the right side in the image.

These key points can be classified into three parts based on their positions on the human body: head, upper limbs and lower limbs. The key points of the head include nose 0, left eye 1, right eye 2, left ear 3 and right ear 4. The key points of the upper limbs include left shoulder 5, right shoulder 6, left elbow 7, right elbow 8, left wrist 9 and right wrist 10. The key points of the lower limbs include left hip 11, right hip 12, left knee 13, right knee 14, left ankle 15 and right ankle 16.

When determining orientation of the target object, the key point recognition module 252 mainly uses directional key points, including left shoulder and right shoulder 6. Specifically, the key point recognition module 252 can determine whether the target object is in front-facing direction, side-facing direction or back-facing direction based on relative position relationships between left shoulder 5 and right shoulder 6. However, in other embodiments, the key point recognition module 252 can also use another type of directional key points, including left hip 11 and right hip 12, to determine whether the target object is in front-facing direction, side-facing direction or back-facing direction based on relative position relationships between left hip 11 and right hip 12.

Through this key point classification method, the key point recognition module 252 can effectively digitize human skeleton structure, facilitating subsequent orientation determination and completeness assessment. This structured key point representation method also enables the system to accurately assess visibility of the target object from different viewing angles.

In an embodiment, determining the orientation of the target object comprises: obtaining one or more directional key points of the target object and a corresponding number thereof; and determining the orientation of the target object based on position relationships of the one or more directional key points in the second image. The following uses FIG. 7B for explanation.

FIG. 7B is a flowchart of determining orientation of a target object according to an embodiment of the present disclosure.

Referring to FIG. 7B, in an embodiment, the completeness encoding module 251 can determine orientation of the target object based on position relationships of directional key points of the target object.

As shown in FIG. 7A, the directional key points include left shoulder 5 and right shoulder 6. In step S710, the completeness encoding module 251 first determines whether only one directional key point exists among the two directional key points. For example, when the target object shows a side view, only left shoulder 5 might be visible while right shoulder 6 is not visible, or only right shoulder 6 might be visible while left shoulder 5 is not visible. If so, then in step S750, the orientation is determined as side-facing direction.

If not, then in step S720, the completeness encoding module 251 further determines whether the left directional key point and right directional key point among the two directional key points are respectively located on the left side and right side in the image. Specifically, the completeness encoding module 251 will check whether left shoulder 5 is located on the left side in the image.

If not (e.g., the left directional key point is located on the right side in the image and the right directional key point is located on the left side in the image), then in step S730, the orientation is determined as front-facing direction. Otherwise, in step S740, the orientation is determined as back-facing direction.

Through this orientation determination process based on directional key point position relationships, the present disclosure can accurately identify orientation of the target object.

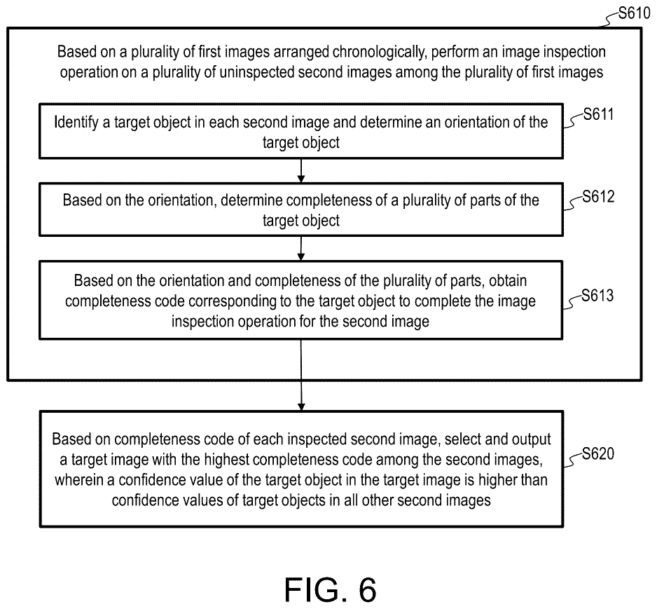

FIG. 6 is a flowchart of an image management method according to an embodiment of the present disclosure.

Referring to FIG. 6, the image management method provided by the present disclosure comprises the following steps.

In step S610, the system (e.g., processor 110 or processor 210) based on a plurality of first images arranged in chronological order, performs an image inspection operation on a plurality of uninspected second images among the plurality of first images. For example, when a customer enters a mall, the image capture device may capture 10 images within 5 seconds, these images are the plurality of first images. The image inspection operation comprises steps S611˜S613.

In step S611, identifying a target object in each second image and determining an orientation of the target object. Continuing the above example, assuming the target object is that customer. The system will identify 8 second images containing that customer from these 10 images, and determine orientation of that customer in each image. For example, the customer may initially enter from the side and then turn to face the camera.

In step S612, based on the orientation, determining completeness of a plurality of parts of the target object. In this example, when the customer shows side view, back view or front view, the system will adjust determination of completeness corresponding to each part of the customer.

In step S613, based on the orientation and the completeness of each of the plurality of parts, obtaining a completeness code corresponding to the target object. For example, when the customer shows a complete front view, it may obtain completeness code “3222”, indicating front-facing and all parts are completely visible.

Finally in step S620, based on the completeness code of each of the inspected 8 second images, selecting and outputting a target image corresponding to a maximum completeness code from the plurality of second images. In this example, the system will select the image with completeness code “3222” from these 10 images as the target image, because the recognition confidence value of the customer in that image is highest.

In an embodiment, wherein the completeness code is an N-digit code, comprising: the Nth digit among the N digits is used to represent the orientation, wherein 0 indicates that the orientation cannot be identified, 1 indicates that the orientation is the side-facing direction indicating that a side-face image of the target object is captured, 2 indicates that the orientation is the back-facing direction indicating that a back-face image of the target object is captured, and 3 indicates that the orientation is the front-facing direction indicating that a front-face image of the target object is captured; the 1st digit to the (N−1)th digit among the N digits are respectively used to represent the completeness of corresponding parts, wherein 0 indicates that an image of the part cannot be identified, 1 indicates that a portion of the image of the part can be identified, and 2 indicates that an entirety of the image of the part can be identified, wherein a numerical value of entirety of the N digits directly reflects a magnitude of the recognition confidence value of the target object in the corresponding second image.

For example, when N=4 and the target object is a person, thousands digit of the four-digit code is used to represent the orientation, wherein 0 indicates that the orientation cannot be identified, 1 indicates that the orientation is the side-facing direction, 2 indicates that the orientation is the back-facing direction, and 3 indicates that the orientation is the front-facing direction; hundreds digit of the four-digit code is used to represent the completeness corresponding to the head image, wherein 0 indicates that the head image cannot be identified, 1 indicates that a portion of the head image can be identified, and 2 indicates that an entirety of the head image can be identified; tens digit of the four-digit code is used to represent the completeness corresponding to the upper limb image, wherein 0 indicates that the upper limb image cannot be identified, 1 indicates that a portion of the upper limb image can be identified, and 2 indicates that an entirety of the upper limb image can be identified; ones digit of the four-digit code is used to represent the completeness corresponding to the lower limb image, wherein 0 indicates that the lower limb image cannot be identified, 1 indicates that a portion of the lower limb image can be identified, and 2 indicates that an entirety of the lower limb image can be identified, wherein a numerical value of entirety of the four-digit code directly reflects a magnitude of the recognition confidence value of the target object in the corresponding second image.

For example, code “3222” represents that the target object shows front-facing direction (3), and head (2), upper limbs (2) and lower limbs (2) are all completely visible; code “2221” represents that the target object shows back-facing direction (2), head (2) and upper limbs (2) are completely visible, while lower limbs (1) are only partially visible; code “1112” represents that the target object shows side-facing direction (1), head (1) and upper limbs (1) are only partially visible, while lower limbs (2) are completely visible.

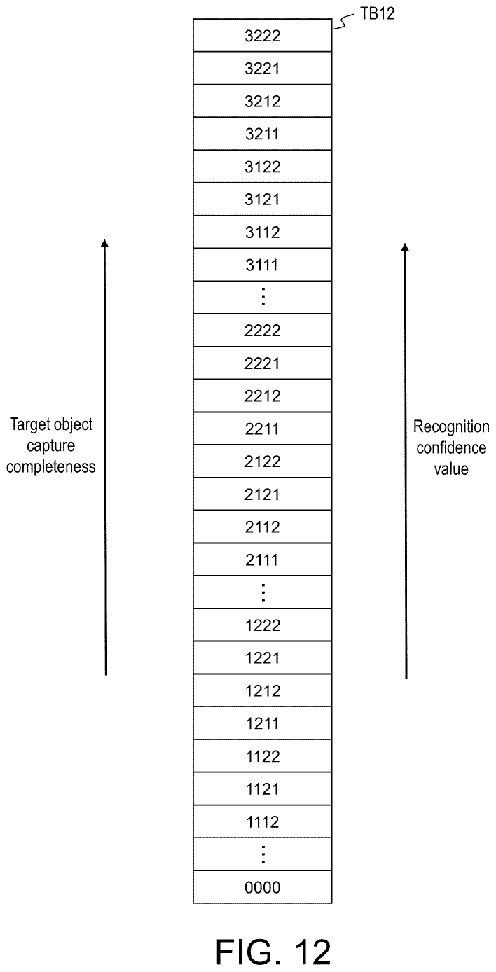

FIG. 12 is a schematic diagram of a completeness code list according to an embodiment of the present disclosure. As shown in FIG. 12, numerical value of the completeness code is positively correlated with recognition confidence value of the target object. When the numerical value of completeness code is higher, it indicates that orientation and visibility of various parts of the target object in the image are better, and the corresponding recognition confidence value is also higher. For example, an image with code “3222” has a higher recognition confidence value than an image with code “2221”, because the former shows front view and all parts are completely visible.

Through this structured coding method, the present disclosure can effectively quantify completeness of the target object and use this as a basis for selecting the optimal target image.

In an embodiment, determining the completeness of each of the plurality of parts of the target object based on the orientation comprises: after determining the orientation, dynamically determining a key point set for evaluating completeness of each part based on the orientation, wherein each key point set comprises a plurality of key points; performing confidence value assessment on each key point in each key point set to obtain a confidence value of each key point; obtaining one or more passed key points from the plurality of key points in each key point set based on the confidence value of each of the plurality of key points in each key point set and a confidence value threshold, wherein the confidence value of each passed key point exceeds the confidence value threshold; and determining the completeness of each part based on a total number of the one or more passed key points of the key point set of each part.

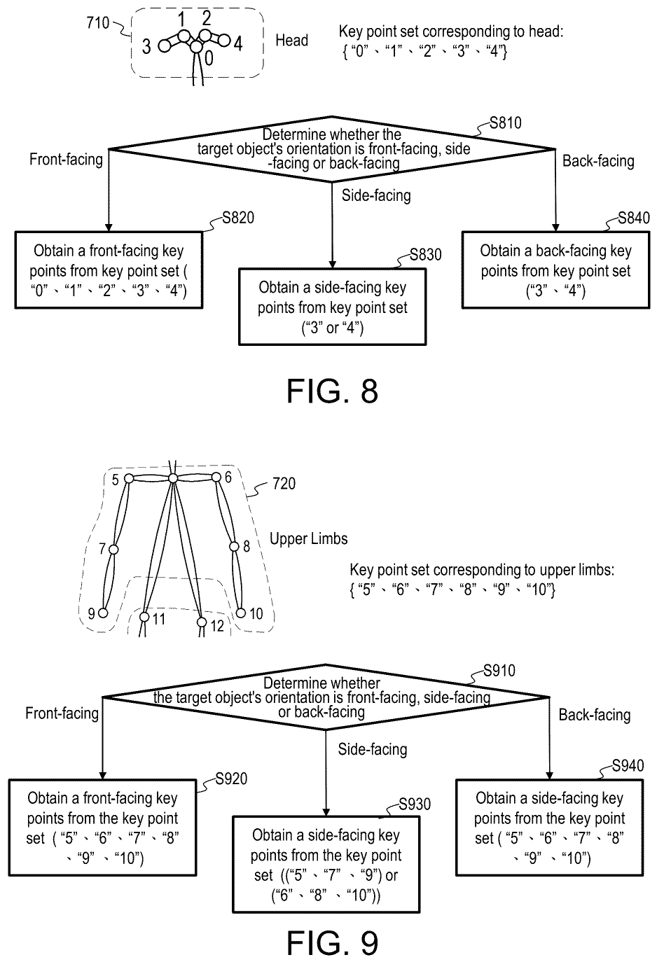

In an embodiment, wherein dynamically determining the key point set for evaluating completeness of each part based on the orientation comprises: when the orientation is the front-facing direction, determining that the key point set of each part comprises a plurality of front-facing key points, wherein when the target object is in the front-facing direction, obtaining the plurality of front-facing key points that can be seen from the target object among the plurality of key points of the key point set corresponding to each part; when the orientation is the back-facing direction, determining that the key point set of each part comprises a plurality of back-facing key points, wherein when the target object is in the back-facing direction, obtaining the plurality of back-facing key points that can be seen from the target object among the plurality of key points of the key point set corresponding to each part; and when the orientation is the side-facing direction, determining that the key point set of each part comprises a plurality of side-facing key points, wherein when the target object is in the side-facing direction, obtaining the plurality of side-facing key points that can be seen from the target object among the plurality of key points of the key point set corresponding to each part, wherein the plurality of front-facing key points, the plurality of back-facing key points and the plurality of side-facing key points belonging to a same key point set are not completely identical to each other. The following uses FIG. 8˜10 for explanation.

FIG. 8 is a flowchart of obtaining a key point set corresponding to a head based on an orientation of a target object according to an embodiment of the present disclosure.

As shown in FIG. 8, region 710 represents a key point distribution diagram of the head, which contains key points including nose 0, left eye 1, right eye 2, left ear 3 and right ear 4. These key points constitute a key point set {0, 1, 2, 3, 4} corresponding to the head.

In step S810, the system first determines whether the target object's orientation is front-facing, side-facing or back-facing. Then, the system will dynamically determine a key point set for evaluating head completeness based on the determined orientation. Specifically:

When determined as front-facing direction, in step S820, obtaining a front-facing key point set, for example including nose 0, left eye 1, right eye 2, left ear 3 and right ear 4. The system performs confidence value assessment on these five key points, if confidence value of a key point exceeds confidence value threshold (for example 0.7), then that key point is considered to have passed assessment. Finally, determining head completeness based on total number of key points that passed assessment.

When determined as side-facing direction, in step S830, obtaining only a side-facing key point set, including either left ear 3 or right ear 4. This is because when a person shows side view, usually only one ear can be seen. The system will similarly perform confidence value assessment only on that key point to determine head completeness.

When determined as back-facing direction, in step S840, obtaining a back-facing key point set, including left ear 3 and right ear 4. This is because when a person shows back view, usually only key points 3, 4 corresponding to both ears can be seen. The system will perform confidence value assessment only on these two key points to determine head completeness.

FIG. 9 is a flowchart of obtaining a key point set corresponding to upper limbs based on an orientation of a target object according to an embodiment of the present disclosure.

As shown in FIG. 9, region 720 represents a key point distribution diagram of the upper limbs, which contains key points including left shoulder 5, right shoulder 6, left elbow 7, right elbow 8, left wrist 9 and right wrist 10. These key points constitute a key point set {5, 6, 7, 8, 9, 10} corresponding to the upper limbs.

In step S910, the system determines whether the target object's orientation is front-facing, side-facing or back-facing. Then, the system will dynamically determine a key point set for evaluating upper limb completeness based on the determined orientation. Specifically:
When determined as front-facing direction, in step S920, obtaining a front-facing key point set, including left shoulder 5, right shoulder 6, left elbow 7, right elbow 8, left wrist 9 and right wrist 10. The system performs confidence value assessment on these six key points, if confidence value of a key point exceeds confidence value threshold, then that key point is considered to have passed assessment. Finally, determining upper limb completeness based on total number of key points that passed assessment.

When determined as side-facing direction, in step S930, obtaining only a side-facing key point set. If left side-facing, then obtaining left side key point set {5, 7, 9}; if right side-facing, then obtaining right side key point set {6, 8, 10}. This is because when a person shows side view, usually only one side of the arms can be seen. The system performs confidence value assessment on these three key points to determine upper limb completeness.

When determined as back-facing direction, in step S940, obtaining a back-facing key point set, also including left shoulder 5, right shoulder 6, left elbow 7, right elbow 8, left wrist 9 and right wrist 10. This is because when a person shows back view, the entire upper limb contour can still be seen. The system performs confidence value assessment on these six key points to determine upper limb completeness.

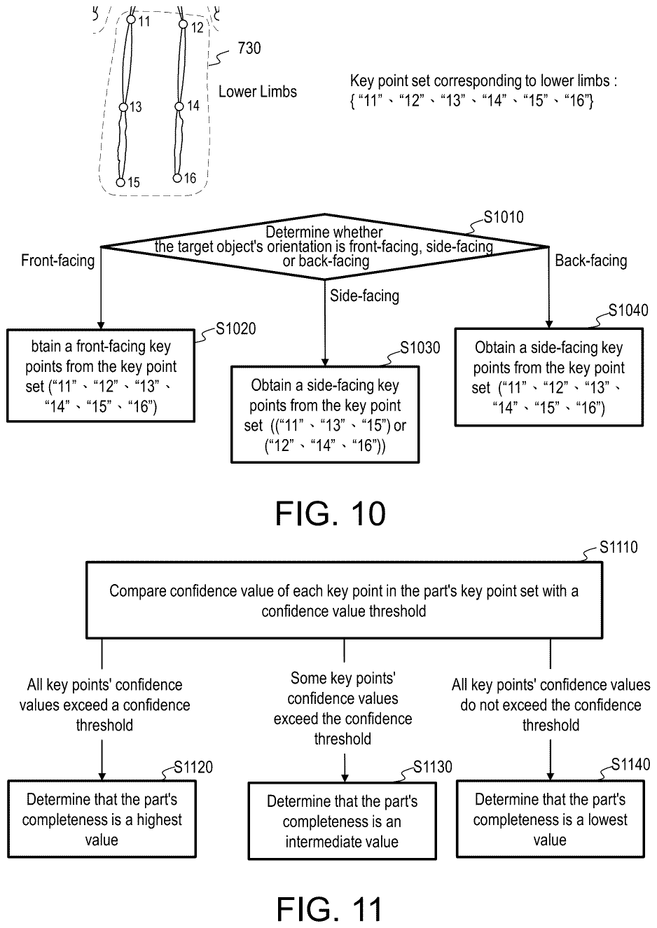

FIG. 10 is a flowchart of obtaining a key point set corresponding to lower limbs based on an orientation of a target object according to an embodiment of the present disclosure.

As shown in FIG. 10, region 730 represents a key point distribution diagram of the lower limbs, which contains key points including left hip 11, right hip 12, left knee 13, right knee 14, left ankle 15 and right ankle 16. These key points constitute a key point set {11, 12, 13, 14, 15, 16} corresponding to the lower limbs.

In step S1010, the system determines whether the target object's orientation is front-facing, side-facing or back-facing. Then, the system will dynamically determine a key point set for evaluating lower limb completeness based on the determined orientation. Specifically:
When determined as front-facing direction, in step S1020, obtaining a front-facing key point set, including left hip 11, right hip 12, left knee 13, right knee 14, left ankle 15 and right ankle 16. The system performs confidence value assessment on these six key points, if confidence value of a key point exceeds confidence value threshold, then that key point is considered to have passed assessment. Finally, determining lower limb completeness based on total number of key points that passed assessment.

When determined as side-facing direction, in step S1030, obtaining only a side-facing key point set. If left side-facing, then obtaining left side key point set {11, 13, 15}; if right side-facing, then obtaining right side key point set {12, 14, 16}. This is because when a person shows side view, usually only one side of the legs can be seen. The system performs confidence value assessment on these three key points to determine lower limb completeness.

When determined as back-facing direction, in step S1040, obtaining a back-facing key point set, also including left hip 11, right hip 12, left knee 13, right knee 14, left ankle 15 and right ankle 16. This is because when a person shows back view, the entire lower limb contour can still be seen. The system performs confidence value assessment on these six key points to determine lower limb completeness.

Through this method of dynamically adjusting key point sets, the present disclosure can select the most suitable key point set for evaluating completeness of each part based on different orientations of the target object, improving assessment accuracy of the system under different viewing angles (can eliminate key points that are inherently not visible in that orientation).

FIG. 11 is a flowchart of determining completeness of a part based on a plurality of key points of a key point set of the part according to an embodiment of the present disclosure.

Referring to FIG. 11, in an embodiment, in step S1110, the system (e.g., processor 110 or processor 210) compares confidence value of each key point in the part's key point set with a preset confidence value threshold. For example, if the confidence value threshold is set to 0.7, then the system determines whether confidence value of each key point exceeds 0.7.

Confidence value threshold: used as a standard value for determining whether key points are reliable. It should be noted that the above confidence value threshold of 0.7 is only for illustrative purposes. In practical applications, setting of this threshold value needs to be determined based on characteristics of the skeleton detection algorithm used by the system. For example, different artificial intelligence models may have different numerical distribution characteristics when outputting confidence values, some models may generally output higher confidence values, while some are more conservative. Therefore, threshold value setting should undergo system calibration and testing to select the most suitable value.

Regarding calculation method of key point confidence values, current common skeleton detection algorithms are mainly based on deep learning technology. These algorithms typically:
use Convolutional Neural Network (CNN) to extract image features; predict possible positions of various key points through heatmap method; calculate confidence values based on heatmap distribution characteristics, for example: height of heatmap peak, concentration degree of heatmap, feature intensity of area surrounding key points.

In practical applications, calculation of confidence values may also need to consider:
image quality (such as resolution, brightness, contrast, etc.), rationality of spatial relationships between key points, temporal continuity (such as consistency with previous and subsequent frames). These factors may all affect final confidence value determination.

Based on comparison results, the system will have three types of determinations:
If in step S1120, it is found that confidence values of all key points in the key point set of that part exceed the confidence value threshold, then completeness of that part is determined as the highest value (i.e., 2). For example, when a person stands straight facing front without occlusion, if confidence values of all five key points of the head (nose, left and right eyes, left and right ears) exceed 0.7, then the system determines head completeness as 2, indicating that the head is completely identifiable (confidence values of all key points exceed the confidence value threshold).

If in step S1130, it is found that only some key points'confidence values exceed the confidence value threshold, then completeness of that part is determined as the intermediate value (i.e., 1). For example, when a person shows side view, if among three key points of the upper limbs (left shoulder, left elbow, left wrist), only confidence values of left shoulder and left elbow exceed 0.7, while left wrist has confidence value below 0.7 due to occlusion, then the system determines upper limb completeness as 1, indicating that the upper limbs are partially identifiable (not completely identifiable).

If in step S1140, it is found that confidence values of all key points of that part do not exceed the confidence value threshold, then completeness of that part is determined as the lowest value (i.e., 0). For example, when lower limbs are completely occluded by a counter, if confidence values of all lower limb key points (left and right hips, left and right knees, left and right ankles) are below 0.7, then the system determines lower limb completeness as 0, indicating that the lower limbs cannot be identified.

In simple terms, completeness code for each part is: 0 (unidentifiable), 1 (partially identifiable), 2 (completely identifiable).

To illustrate with a practical example, assume a customer stands at a mall counter, determined to be in side-facing direction (corresponding code is 1):
Regarding the head, because it is side-facing direction (assume right side), the system only needs to assess confidence value of right ear key point 4. This key point has confidence value of 0.92, exceeding threshold value 0.7, therefore head completeness is 2, indicating head is completely visible in side-facing direction.

Regarding upper limbs, because it is side-facing direction and right side-facing, the system assesses right side key point set {6, 8, 10}, namely confidence values of right shoulder, right elbow and right wrist. These key points have confidence values of: right shoulder (0.88), right elbow (0.85), right wrist (0.65). Because right wrist's confidence value is below threshold value, while the other two key points exceed threshold value, upper limb completeness is 1, indicating upper limbs are partially visible in side-facing direction.

Regarding lower limbs, because it is side-facing direction and right side-facing, the system assesses right side key point set {12, 14, 16}, namely right hip, right knee and right ankle confidence values. Because lower body is occluded by the counter, these key points all have confidence values below 0.5, therefore lower limb completeness is 0, indicating lower limbs cannot be identified in side-facing direction.

Finally, the obtained completeness code for this image is “1210”, wherein: “1” indicates side-facing direction, “2” indicates head is completely visible in side-facing direction (only needs one ear key point), “1” indicates upper limbs are partially visible in side-facing direction (two out of three right side key points are reliable), “0” indicates lower limbs are completely invisible in side-facing direction.

In an embodiment, selecting and outputting the target image corresponding to the maximum completeness code from the plurality of second images comprises: arranging the plurality of completeness codes of the plurality of second images in chronological order of the plurality of second images to form a code sequence; analyzing a numerical trend of the code sequence to identify a maximum value in the code sequence; selecting an image corresponding to the maximum value as the target image to output the target image.

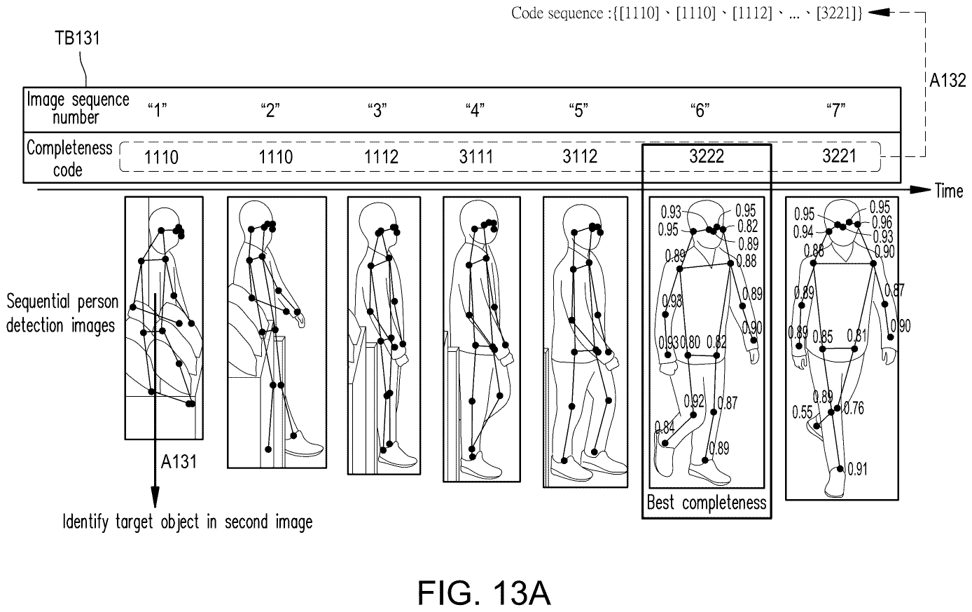

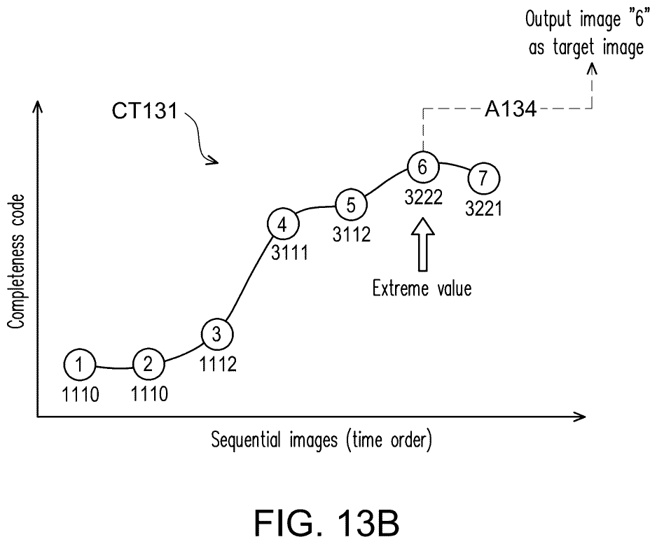

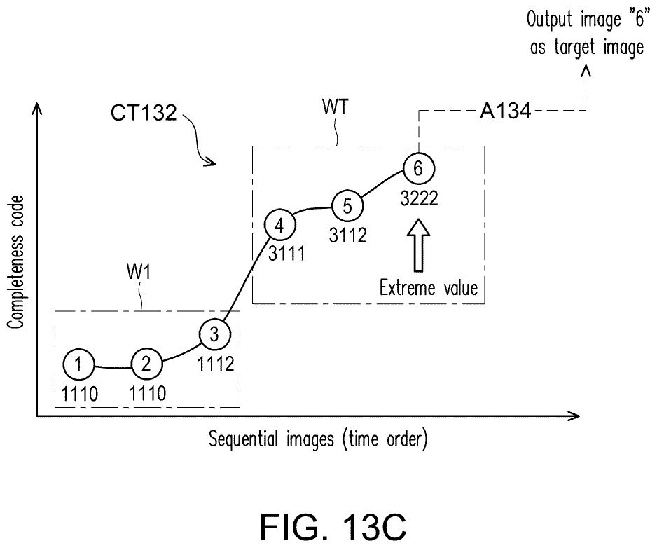

FIG. 13A is a schematic diagram of performing completeness coding on a plurality of images according to an embodiment of the present disclosure.

In an embodiment, as shown in table TB131, which records image sequence numbers and corresponding completeness codes of a plurality of second images captured in chronological sequence. As indicated by arrow A132, based on time ordering of these second images and their corresponding completeness codes, a code sequence {[1110], [1110], [1112], . . . , [3221]} can be obtained.

In this example, the system continuously captured 7 second images containing the target object, these images are sequentially marked as “1” to “7”. The system performs key point analysis on the target object in each image and generates corresponding completeness codes. These codes are arranged in chronological order as follows:
Image “1”: code is 1110, indicating side view and only head and upper limbs are partially identifiable (lower limb image of the person cannot be identified due to occlusion by other objects).
It should be noted that for image “1”, as indicated by arrow A131, the system can identify the target object.

Image “2”: code is 1110, the person is preparing to stand up, lower limbs are still unidentifiable.

Image “3”: code is 1112, lower limbs become completely visible.

Image “4”: code is 3111, person's orientation turns to front-facing but various parts are only partially visible.

Image “5”: code is 3112, lower limbs become completely visible.

Image “6”: code is 3222, all parts are completely visible (optimal completeness).

Image “7”: code is 3221, lower limbs become partially visible (left ankle is occluded).

For ease of explanation, key point confidence values are only marked on images “6” and “7”. In image “6”, the system recorded confidence values for each key point (such as 0.93, 0.95, etc.), these values all exceed the confidence value threshold, therefore obtaining the highest completeness code 3222. This image is also marked as “optimal completeness”, indicating that in this continuous capture process, this image is most suitable for subsequent person re-identification processing. In image “7”, one key point of lower limbs has confidence value not exceeding the confidence value threshold, therefore not all key points of lower limbs exceed the confidence value threshold, determined as code 1, thus making the corresponding completeness code 3221.

Through this method of arranging completeness codes in chronological sequence, the system can track completeness variation trend of the target object, effectively finding images most suitable for person re-identification.

FIG. 13B is a schematic diagram of outputting a target image by analyzing a numerical trend of a code sequence according to an embodiment of the present disclosure.

Referring to FIG. 13B, continuing the example of FIG. 13A, the code sequence can be represented by graph CT131, which shows trend of corresponding completeness codes changing over time.

Specifically, the system first arranges completeness codes of 7 continuously captured second images in chronological order to form a code sequence:
Image “1”: 1110 (initial side view);
Image “2”: 1110 (maintaining side view);
Image “3”: 1112 (side view, lower limb completeness improved);
Image “4”: 3111 (turned to front view);
Image “5”: 3112 (front view, lower limb completeness improved);
Image “6”: 3222 (front view, optimal completeness), this is the extreme value in this code sequence;
Image “7”: 3221 (front view, lower limb completeness slightly decreased).

The system analyzes numerical trend of this code sequence and observes that:
Early stage (images “1” to “3”) maintains side view state, with slight increase in completeness;
Middle stage (images “4” to “5”) turns to front view, but completeness is still in process of improvement;
Late stage (images “6” to “7”) reaches peak then begins to decline.

Through trend analysis, the system identifies the maximum value in the code sequence as code 3222 of image “6”. Therefore, as indicated by arrow A134, the system selects image “6” as the target image for output, because this image not only shows front view, but head, upper limbs and lower limbs all achieve optimal completeness.

Through this image selection method based on trend analysis, the present disclosure can effectively find the most complete image of the target object during movement, avoiding selection of partially occluded or poorly posed images, thereby improving accuracy of subsequent person re-identification.

Furthermore, in another embodiment, analyzing the numerical trend of the code sequence further comprises: analyzing only a partial code sequence within a time window of the code sequence; determining whether a maximum value in the partial code sequence exceeds a preset completeness code threshold value, wherein when the maximum value does not exceed the preset completeness code threshold value, moving the time window to a next position and repeating the above steps; when the maximum value exceeds the preset completeness code threshold value, selecting the second image corresponding to the maximum value as the target image and stopping analysis of subsequent second images. The following uses FIG. 13C for explanation.

FIG. 13C is a schematic diagram of performing completeness coding on a plurality of images according to an embodiment of the present disclosure.

Continuing the example of FIG. 13A, in an embodiment, the system further uses time windows to analyze completeness coding of multiple images. As shown in FIG. 13C, the figure shows a trend curve CT132 corresponding to the code sequence, where the system uses sliding time windows (as shown by W1 and WT) to analyze local trends of the code sequence.

Specifically, the system first sets a time window W1 containing the initial three images:
image “1”: 1110; image “2”: 1110; image “3”: 1112. The system analyzes partial code sequence 1110, 1110, 1112 within time window W1, finding maximum value to be 1112. Assuming the preset completeness code threshold value is 3110, since 1112 is less than this threshold value, the system moves the time window to the next position.

Then, obtaining time window WT, which contains: image “4”: 3111; image “5”: 3112;image “6”: 3222. Next, the system analyzes the code sequence within time window WT, finding maximum value to be 3222. Because 3222 exceeds the preset completeness code threshold value 3110, the system immediately selects image “6” as the target image (as shown in region A134), and stops analysis of subsequent images (such as image “7”). This early stopping mechanism can reduce unnecessary computational burden, allowing system computational resources to be used for processing other target objects or other tasks.

Through this sliding time window analysis method, the present disclosure has the following advantages: can process large amounts of image data in parallel through multiple windows; can stop analysis once a qualifying image is found, saving computational resources, thereby improving system response speed.

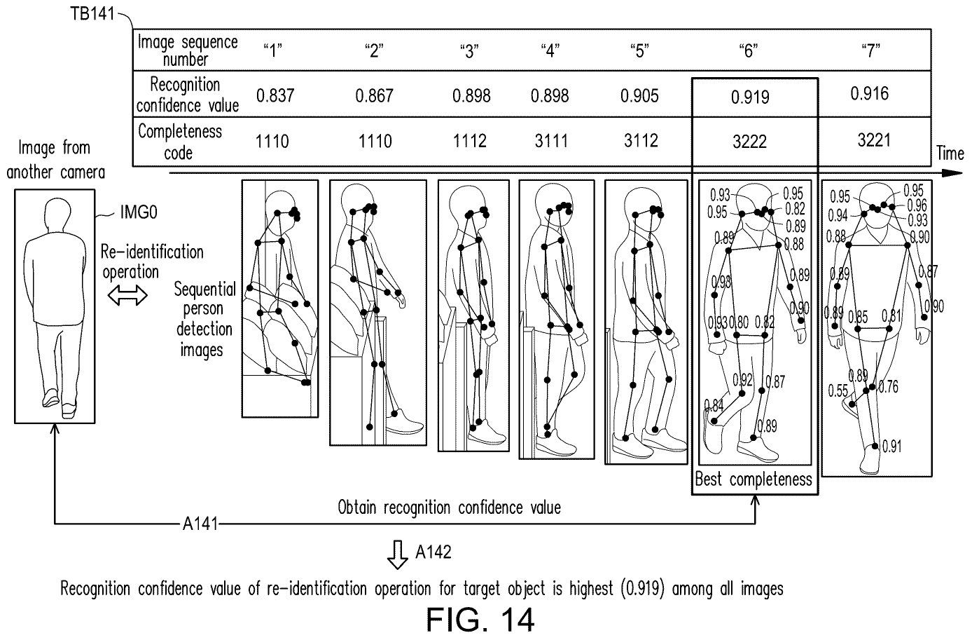

FIG. 14 is a schematic diagram of obtaining a target image based on a numerical trend of a code sequence of a plurality of completeness codes corresponding to a plurality of images according to an embodiment of the present disclosure.

In an embodiment, FIG. 14 shows performing person re-identification between continuously captured images and a target image IMG0 captured by another camera according to an embodiment of the present disclosure. As shown in table TB141, which records sequence number, completeness code and corresponding recognition confidence value for each image.

As indicated by arrow 141, the system performs re-identification operation on each image. Specifically, the system performs person re-identification comparison between these 7 continuously captured images and IMG0 respectively, obtaining different recognition confidence values:
Image “1” (completeness code 1110): recognition confidence value is 0.837;
Image “2” (completeness code 1110): recognition confidence value is 0.867;
Image “3” (completeness code 1112): recognition confidence value is 0.898;
Image “4” (completeness code 3111): recognition confidence value is 0.898;
Image “5” (completeness code 3112): recognition confidence value is 0.905;
Image “6” (completeness code 3222): recognition confidence value is 0.919;
Image “7” (completeness code 3221): recognition confidence value is 0.916.

As indicated by arrow A142, image “6” not only has the highest completeness code 3222, its corresponding recognition confidence value 0.919 is also the highest among all images. This result validates effectiveness of the completeness code mechanism of the present disclosure, namely that images with higher completeness codes can indeed provide better re-identification effects.

Through this example, it reflects that: recognition confidence value of subsequent processing (such as re-identification operation) increases with improvement of completeness code; when the target object shows front view and all parts are completely visible (code 3222), optimal re-identification effect can be obtained; even slight decrease in completeness (from 3222 to 3221) will lead to corresponding decrease in recognition confidence value (from 0.919 to 0.916).

In an embodiment, after the best completeness image of the target object is selected as the target image, the system will input the target image to a person re-identification model for further identity recognition operation. Taking the embodiment shown in FIG. 14 as an example, the system selects image “6” with highest completeness code 3222 from continuously captured multiple second images as the target image.

Then, as indicated by arrow A141, the system performs person re-identification operation between this target image and target object image IMG0 captured by another camera. Through computation of the person re-identification model, the system can obtain similarity degree between these two images, namely recognition confidence value. When the recognition confidence value exceeds preset threshold value, the system determines that persons in these two images are the same person.

In this example, because the target image has optimal completeness (code 3222), its corresponding recognition confidence value reaches 0.919, significantly higher than images captured at other time points. This validates that the method of the present disclosure can not only effectively select images of optimal quality, but can also substantially improve accuracy of person re-identification.

A person re-identification (Person Re-identification, Re-ID) model is a deep learning model specifically used for cross-camera person recognition. Its main purpose is to determine whether person images captured by different cameras, at different times or in different scenes are the same person.

A person re-identification model typically contains the following key technical features:
(1) Feature extraction: using Convolutional Neural Network (CNN) to automatically learn appearance features of persons; extracting global features (such as overall clothing color, body type) and local features (such as clothing texture, accessories); focusing on salient regions in person images to reduce background interference.
(2) Feature representation: converting extracted visual features into high-dimensional feature vectors; designing special feature aggregation strategies to enhance feature discriminability; adopting attention mechanism to highlight important visual cues.
(3) Similarity calculation: calculating distance or similarity between feature vectors of different images; commonly used metrics include Euclidean distance, cosine similarity, etc.; outputting a recognition confidence value between 0 and 1.

Through the image management method provided by the present disclosure, sufficient completeness of images input to the re-identification model can be ensured, effectively improving recognition accuracy of the model.

Through the above embodiments, the present disclosure has the following technical benefits:

First, regarding image acquisition and analysis:
(1) The present disclosure provides a systematic method that can find images most suitable for person re-identification from continuous images, overcoming the problem of traditional person detection easily capturing incomplete images.
(2) Through mechanism of dynamically adjusting key point sets, assessment accuracy of completeness determination can be improved by selecting most suitable key points based on person's orientation (front-facing, side-facing or back-facing).
(3) Adopting sliding time window analysis method, analysis can be stopped once qualifying images are found, effectively reducing unnecessary computational burden.

Second, regarding code design:
(1) The four-digit completeness code designed by the present disclosure can effectively integrate orientation information and completeness information of various parts of target objects, providing a concise and intuitive completeness quantification indicator.
(2) The numerical value of completeness code shows positive correlation with recognition confidence value of re-identification results, validating effectiveness of the coding mechanism proposed by the present disclosure.
(3) Through analysis of code sequence trends, the system can track completeness variation of target objects and find optimal capture timing in real time.

Third, regarding practical applications:
(1) The present disclosure can be integrated into existing image capture devices, completing image filtering at the edge, reducing network transmission load.
(2) The system only needs to transmit images with optimal completeness to the server, substantially improving overall performance of person re-identification systems.
(3) Applicable to various complex scenes, such as malls, exhibitions and other environments with dense crowds and frequent occlusions.

Based on the above, the image management method, server and image capture device provided by one or more embodiments of the present disclosure can identify a plurality of second images containing target objects from a plurality of first images arranged in chronological order, and generate corresponding completeness codes through determining orientation of target objects and completeness of their multiple parts. Through analyzing numerical trends of these completeness codes, the system can effectively select target images most suitable for person re-identification. This method not only solves the problem of traditional person detection easily capturing incomplete images, but also improves accuracy of completeness determination through dynamically adjusted key point set mechanism. Furthermore, completeness codes designed by the present disclosure show positive correlation with actual re-identification effects, proving reliability of this method in practical applications. Through mechanism of filtering optimal images at the edge in real time, the present disclosure can also effectively reduce network transmission load and improve overall system performance.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An image management method, comprising:
based on a plurality of first images arranged in chronological order, performing an image inspection operation on a plurality of uninspected second images among the plurality of first images, wherein the image inspection operation comprises:
identifying a target object in each second image and determining an orientation of the target object;
based on the orientation, determining completeness of a plurality of parts of the target object; and
based on the orientation and the completeness of each of the plurality of parts, obtaining a completeness code corresponding to the target object, so as to complete the image inspection operation corresponding to the second image; and
based on the completeness code of each of the inspected plurality of second images, selecting and outputting a target image corresponding to a maximum completeness code from the plurality of second images, wherein a recognition confidence value of the target object in the target image is greater than recognition confidence values of the target object in each of other second images among the plurality of second images.

2. The image management method as claimed in claim 1, wherein the target object is an image corresponding to a person,
wherein the orientation comprises:
a front-facing direction, a side-facing direction and a back-facing direction corresponding to the person,
wherein the plurality of parts comprises:
a head image corresponding to a head of the person, an upper limb image corresponding to upper limbs of the person, and a lower limb image corresponding to lower limbs of the person.

3. The image management method as claimed in claim 1, wherein the completeness code is an N-digit code, comprising:
the Nth digit among the N digits is used to represent the orientation, wherein 0 indicates that the orientation cannot be identified, 1 indicates that the orientation is the side-facing direction indicating that a side-face image of the target object is captured, 2 indicates that the orientation is the back-facing direction indicating that a back-face image of the target object is captured, and 3 indicates that the orientation is the front-facing direction indicating that a front-face image of the target object is captured;
the 1st digit to the (N−1)th digit among the N digits are respectively used to represent the completeness of corresponding parts, wherein 0 indicates that an image of the part cannot be identified, 1 indicates that a portion of the image of the part can be identified, and 2 indicates that an entirety of the image of the part can be identified,
wherein a numerical value of entirety of the N digits directly reflects a magnitude of the recognition confidence value of the target object in the corresponding second image.

4. The image management method as claimed in claim 3, wherein the N-digit code is a four-digit code, comprising:
thousands digit of the four-digit code is used to represent the orientation, wherein 0 indicates that the orientation cannot be identified, 1 indicates that the orientation is the side-facing direction, 2 indicates that the orientation is the back-facing direction, and 3 indicates that the orientation is the front-facing direction;
hundreds digit of the four-digit code is used to represent the completeness corresponding to the head image, wherein 0 indicates that the head image cannot be identified, 1 indicates that a portion of the head image can be identified, and 2 indicates that an entirety of the head image can be identified;
tens digit of the four-digit code is used to represent the completeness corresponding to the upper limb image, wherein 0 indicates that the upper limb image cannot be identified, 1 indicates that a portion of the upper limb image can be identified, and 2 indicates that an entirety of the upper limb image can be identified;
ones digit of the four-digit code is used to represent the completeness corresponding to the lower limb image, wherein 0 indicates that the lower limb image cannot be identified, 1 indicates that a portion of the lower limb image can be identified, and 2 indicates that an entirety of the lower limb image can be identified,
wherein a numerical value of entirety of the four-digit code directly reflects a magnitude of the recognition confidence value of the target object in the corresponding second image.

5. The image management method as claimed in claim 3, wherein determining the orientation of the target object comprises:
obtaining one or more directional key points of the target object and a corresponding number thereof; and
determining the orientation of the target object based on position relationships of the one or more directional key points in the second image.

6. The image management method as claimed in claim 5, wherein determining the completeness of each of the plurality of parts of the target object based on the orientation comprises:
after determining the orientation, dynamically determining a key point set for evaluating completeness of each part based on the orientation, wherein each key point set comprises a plurality of key points;
performing confidence value assessment on each key point in each key point set to obtain a confidence value of each key point;
obtaining one or more passed key points from the plurality of key points in each key point set based on the confidence value of each of the plurality of key points in each key point set and a confidence value threshold, wherein the confidence value of each passed key point exceeds the confidence value threshold; and
determining the completeness of each part based on a total number of the one or more passed key points of the key point set of each part.

7. The image management method as claimed in claim 6, wherein dynamically determining the key point set for evaluating completeness of each part based on the orientation comprises:
when the orientation is the front-facing direction, determining that the key point set of each part comprises a plurality of front-facing key points, wherein when the target object is in the front-facing direction, obtaining the plurality of front-facing key points that can be seen from the target object among the plurality of key points of the key point set corresponding to each part;
when the orientation is the back-facing direction, determining that the key point set of each part comprises a plurality of back-facing key points, wherein when the target object is in the back-facing direction, obtaining the plurality of back-facing key points that can be seen from the target object among the plurality of key points of the key point set corresponding to each part; and
when the orientation is the side-facing direction, determining that the key point set of each part comprises a plurality of side-facing key points, wherein when the target object is in the side-facing direction, obtaining the plurality of side-facing key points that can be seen from the target object among the plurality of key points of the key point set corresponding to each part, wherein the plurality of front-facing key points, the plurality of back-facing key points and the plurality of side-facing key points belonging to a same key point set are not completely identical to each other.

8. The image management method as claimed in claim 1, wherein selecting and outputting the target image corresponding to the maximum completeness code from the plurality of second images comprises:
arranging the plurality of completeness codes of the plurality of second images in chronological order of the plurality of second images to form a code sequence;
analyzing a numerical trend of the code sequence to identify a maximum value in the code sequence;
selecting an image corresponding to the maximum value as the target image to output the target image.

9. The image management method as claimed in claim 8, wherein analyzing the numerical trend of the code sequence further comprises:
analyzing only a partial code sequence within a time window of the code sequence;
determining whether a maximum value in the partial code sequence exceeds a preset completeness code threshold value,
wherein when the maximum value does not exceed the preset completeness code threshold value, moving the time window to a next position and repeating the above steps;
when the maximum value exceeds the preset completeness code threshold value, selecting the second image corresponding to the maximum value as the target image and stopping analysis of subsequent second images.

10. The image management method as claimed in claim 1, further comprising:
inputting the target image to a person re-identification model to perform a person identity recognition operation.

11. A server, comprising:
a processor;
a memory coupled to the processor; and
a storage device coupled to the processor, wherein the storage device stores a plurality of program modules, and the processor is configured to execute the plurality of program modules to:
based on a plurality of first images arranged in chronological order, perform an image inspection operation on a plurality of uninspected second images among the plurality of first images, wherein the image inspection operation comprises:
identifying a target object in each second image and determining an orientation of the target object;
based on the orientation, determining completeness of a plurality of parts of the target object; and
based on the orientation and the completeness of each of the plurality of parts, obtaining a completeness code corresponding to the target object, so as to complete the image inspection operation corresponding to the second image; and
based on the completeness code of each of the inspected plurality of second images, select and output a target image corresponding to a maximum completeness code from the plurality of second images, wherein a recognition confidence value of the target object in the target image is greater than recognition confidence values of the target object in each of other second images among the plurality of second images.

12. The image management method as claimed in claim 11, wherein the target object is an image corresponding to a person,
wherein the orientation comprises:
a front-facing direction, a side-facing direction and a back-facing direction corresponding to the person,
wherein the plurality of parts comprises:
a head image corresponding to a head of the person, an upper limb image corresponding to upper limbs of the person, and a lower limb image corresponding to lower limbs of the person.

13. The image management method as claimed in claim 11, wherein the completeness code is an N-digit code, comprising:
the Nth digit among the N digits is used to represent the orientation, wherein 0 indicates that the orientation cannot be identified, 1 indicates that the orientation is the side-facing direction indicating that a side-face image of the target object is captured, 2 indicates that the orientation is the back-facing direction indicating that a back-face image of the target object is captured, and 3 indicates that the orientation is the front-facing direction indicating that a front-face image of the target object is captured;
the 1st digit to the (N−1)th digit among the N digits are respectively used to represent the completeness of corresponding parts, wherein 0 indicates that an image of the part cannot be identified, 1 indicates that a portion of the image of the part can be identified, and 2 indicates that an entirety of the image of the part can be identified,
wherein a numerical value of entirety of the N digits directly reflects a magnitude of the recognition confidence value of the target object in the corresponding second image.

14. The server as claimed in claim 13, wherein the N-digit code is a four-digit code, comprising:
thousands digit of the four-digit code is used to represent the orientation, wherein 0 indicates that the orientation cannot be identified, 1 indicates that the orientation is the side-facing direction, 2 indicates that the orientation is the back-facing direction, and 3 indicates that the orientation is the front-facing direction;
hundreds digit of the four-digit code is used to represent the completeness corresponding to the head image, wherein 0 indicates that the head image cannot be identified, 1 indicates that a portion of the head image can be identified, and 2 indicates that an entirety of the head image can be identified,
tens digit of the four-digit code is used to represent the completeness corresponding to the upper limb image, wherein 0 indicates that the upper limb image cannot be identified, 1 indicates that a portion of the upper limb image can be identified, and 2 indicates that an entirety of the upper limb image can be identified,
ones digit of the four-digit code is used to represent the completeness corresponding to the lower limb image, wherein 0 indicates that the lower limb image cannot be identified, 1 indicates that a portion of the lower limb image can be identified, and 2 indicates that an entirety of the lower limb image can be identified,
wherein a numerical value of entirety of the four-digit code directly reflects a magnitude of the recognition confidence value of the target object in the corresponding second image.

15. The server as claimed in claim 14, wherein determining the orientation of the target object comprises:
obtaining one or more directional key points of the target object and a corresponding number thereof; and
determining the orientation of the target object based on position relationships of the one or more directional key points in the second image.

16. The server as claimed in claim 15, wherein determining the completeness of each of the plurality of parts of the target object based on the orientation comprises:
after determining the orientation, dynamically determining a key point set for evaluating completeness of each part based on the orientation, wherein each key point set comprises a plurality of key points;
performing confidence value assessment on each key point in each key point set to obtain a confidence value of each key point;
obtaining one or more passed key points from the plurality of key points in each key point set based on the confidence value of each of the plurality of key points in each key point set and a confidence value threshold, wherein the confidence value of each passed key point exceeds the confidence value threshold; and
determining the completeness of each part based on a total number of the one or more passed key points of the key point set of each part.

17. The server as claimed in claim 16, wherein dynamically determining the key point set for evaluating completeness of each part based on the orientation comprises:
when the orientation is the front-facing direction, determining that the key point set of each part comprises a plurality of front-facing key points, wherein when the target object is in the front-facing direction, obtaining the plurality of front-facing key points that can be seen from the target object among the plurality of key points of the key point set corresponding to each part;
when the orientation is the back-facing direction, determining that the key point set of each part comprises a plurality of back-facing key points, wherein when the target object is in the back-facing direction, obtaining the plurality of back-facing key points that can be seen from the target object among the plurality of key points of the key point set corresponding to each part; and
when the orientation is the side-facing direction, determining that the key point set of each part comprises a plurality of side-facing key points, wherein when the target object is in the side-facing direction, obtaining the plurality of side-facing key points that can be seen from the target object among the plurality of key points of the key point set corresponding to each part, wherein the plurality of front-facing key points, the plurality of back-facing key points and the plurality of side-facing key points belonging to a same key point set are not completely identical to each other.

18. The server as claimed in claim 11, wherein selecting and outputting the target image corresponding to the maximum completeness code from the plurality of second images comprises:
arranging the plurality of completeness codes of the plurality of second images in chronological order of the plurality of second images to form a code sequence;
analyzing a numerical trend of the code sequence to identify a maximum value in the code sequence;
selecting an image corresponding to the maximum value as the target image to output the target image.

19. The server as claimed in claim 18, wherein analyzing the numerical trend of the code sequence further comprises:
analyzing only a partial code sequence within a time window of the code sequence;
determining whether a maximum value in the partial code sequence exceeds a preset completeness code threshold value,
wherein when the maximum value does not exceed the preset completeness code threshold value, moving the time window to a next position and repeating the above steps;
when the maximum value exceeds the preset completeness code threshold value, selecting the second image corresponding to the maximum value as the target image and stopping analysis of subsequent second images.

20. The server as claimed in claim 11, wherein the processor is further configured to:
input the target image to a person re-identification model to perform a person identity recognition operation.

21. An image capture device, comprising:
a camera module for capturing a plurality of first images;
a processor;
a memory coupled to the processor; and
a storage device coupled to the processor, wherein the storage device stores a plurality of program modules, and the processor is configured to execute the plurality of program modules to:
based on the plurality of first images arranged in chronological order, perform an image inspection operation on a plurality of uninspected second images among the plurality of first images, wherein the image inspection operation comprises:
identifying a target object in each second image and determining an orientation of the target object;
based on the orientation, determining completeness of a plurality of parts of the target object; and
based on the orientation and the completeness of each of the plurality of parts, obtaining a completeness code corresponding to the target object, so as to complete the image inspection operation corresponding to the second image; and
based on the completeness code of each of the inspected plurality of second images, select and output a target image corresponding to a maximum completeness code from the plurality of second images, wherein a recognition confidence value of the target object in the target image is greater than recognition confidence values of the target object in each of other second images among the plurality of second images.
